(19) United States
(12) Patent Application Publication
(10) Pub. No.: US 2025/0163834 A1
(43) Pub. Date: May 22, 2025

(54) COLLECTING COMPONENT FOR AN OIL GUIDING ARRANGEMENT

(71) Applicant: ZF Friedrichshafen AG, Friedrichshafen (DE)

(72) Inventor: Tamas GYARMATI, Bermatingen (DE)

(21) Appl. No.: 18/954,096

(22) Filed: Nov. 20, 2024

(30) Foreign Application Priority Data
Nov. 20, 2023 (DE) 102023211493.3

(51) Int. Cl. F01M 11/02; B60K 11/02; H02K 1/32

(52) U.S. Cl. CPC F01M 11/02; B60K 11/02; H02K 1/32

(57) ABSTRACT

A collecting component for an oil guiding arrangement having a wall section defining a main oil channel. The collecting component defines an input opening at an upper side of the collecting component, the input opening being configured for both receiving oil dripping from the wall section and oil flowing out of the main oil channel. The collecting component further defines a supply section that at least partially defines the input opening. The collecting component defines an output opening at an underside of the collecting component and opposite the supply section in an axial direction. The collecting component defines a guide section configured for guiding oil from the wall section and the main oil channel to the output opening in the axial direction. The collecting component additionally defines a fastening section configured for fastening the collecting component to the wall section.

### CROSS-REFERENCE TO RELATED APPLICATION

The present application is related and has right of priority to German Patent Application No. 10 2023 211 493.3 filed on Nov. 20, 2023, the entirety of which is incorporated by reference for all purposes.

### FIELD OF THE INVENTION

The present invention relates generally to a collecting component for an oil guiding arrangement, an oil guiding arrangement for a drive unit, a drive unit for a vehicle, and a vehicle.

### BACKGROUND

Oil guiding arrangements supplying oil to different components of a drive unit for lubrication and cooling are known. The drive unit can have an electric drive with a rotor and a rotor bearing. The rotor bearing can be accommodated in a housing. The rotor bearing can be located within the rotor in the axial direction. The oil guidance to the rotor bearing by an oil duct in the housing is complex.

### SUMMARY OF THE INVENTION

It is an object of the present invention to provide an improved oil guiding arrangement, which enables oil guidance to a rotor bearing in a simple manner and ensures good oiling.

A collecting component for an oil guiding arrangement, which includes a wall section, is provided. The wall section forms a main oil channel. The wall section may form the main oil channel sectionwise. The collecting component defines an input opening, a supply section, a guide section, an output opening, and a fastening section.

The fastening section is configured for fastening the collecting component to the wall section. Two fastening sections may be provided. One of the fastening sections may be formed by at least one clip. One of the fastening sections may have three clips. One of the clips may be an elastic hook element projecting in an axial direction. The clips of one of the fastening sections may be spaced apart in a circular manner. One of the fastening sections may be a tab for a screw connection. One of the fastening sections may project from the guide section in an axial direction. The collecting component is usable for a drive unit which has a rotor bearing with an axis of rotation. The axial direction is along the direction of the axis of rotation of the rotor bearing. The fastening sections may be arranged radially symmetrically with respect to an axis of rotation of the rotor bearing.

The input opening is arranged at an upper side of the collecting component. The input opening is formed section-wise, or in part, by the supply section. The input opening is configured for both receiving oil dripping from the wall section as well as for receiving oil flowing out of the main oil channel. The input opening may be configured for receiving oil dripping from the wall section in the direction of gravity.

The direction of gravity results when the collecting component is used as intended in a drive unit with the oil guiding arrangement. When used as intended, the collecting component may be fastened to the wall section by at least one fastening section.

The input opening may cover the wall section in an axial direction. For example, the input opening may protrude beyond an end face of the wall section in an axial direction on the side of the supply section. The input opening may be substantially rectangular in a circumferential direction. The input opening may define an arc-shaped contour in a radial direction (e.g., when viewed along the axial direction). The input opening may be configured in a circular manner in a radial direction and concentrically with respect to the axis of rotation of the rotor bearing.

The guide section is configured for guiding oil from the wall section and the main oil channel to the output opening in an axial direction. The guide section may extend from the output opening to the input opening. The input opening may form the upper side of the guide section in the direction of gravity.

The output opening is defined on an underside of the collecting component and opposite the supply section in the axial direction. The underside of the collecting component may be arranged at the bottom with respect to the direction of gravity. The output opening may be defined at a lowest point in the direction of gravity of the guide section. The output opening may be formed in a cylindrical depression. The cylindrical depression may be aligned in an axial direction. The output opening may be defined by a cylindrical bore. The output opening may extend in an axial direction and in a radial direction. The radial direction may be a radial direction of the rotor bearing. The output opening may extend in the direction of the rotor bearing.

In an embodiment, a first radial surface and a second radial surface of the guide section may be arranged opposite each other in a circumferential direction. The first radial surface and the second radial surface may taper toward each other at an angle in a radial direction. The first radial surface and the second radial surface may be connected to the cylindrical depression in a radial direction on the inside. The first radial surface may be configured such that it may receive slung oil. The first radial surface may be steeper than the second radial surface with respect to the direction of gravity. If a radial surface is steep, this may mean that an angle of the radial surface relative to the direction of gravity is small. The collecting component is usable for a drive unit which includes a first gearset. Slung oil may be the oil which is slung from the first gearset in a circumferential direction during operation in which a gearset element of the first gearset rotates. A slinging direction of the slung oil may have a radial component due to a centrifugal force.

One of the first radial surface and the second radial surface may be aligned in an axial direction. One of the first radial surface and the second radial surface may extend substantially in a radial direction. The first radial surface and the second radial surface may be oriented such that the contour of the guide section is configured in a radial direction in a v-shaped or triangular manner. The first radial surface and the second radial surface may be arranged such that the guide section is configured in a radial direction in a funnel-shaped manner. The first radial surface and the second radial surface may form an obtuse angle to each other. The first radial surface may project further upward in the direction of gravity. As a result, during operation, an oil surface may be accommodated in the guide section, which due to an oil pressure may be formed obliquely by the movement of the first gearset.

In one embodiment, axial surfaces arranged laterally in an axial direction may be substantially parallel to each other. The axial surfaces may extend in a radial direction and may be arranged in a circumferential direction. Axial surfaces may be located opposite each other in an axial direction with respect to the input opening.

In one embodiment, the guide section may define at least one step. A plurality of steps may be defined. Two steps may be defined. The steps may be stepwise closer to the output opening. The closer a step is to the output opening in an axial direction, the closer the step may be to the output opening in a radial direction. One of the steps may have an arc-shaped outer circumference. The outer circumference of the steps may be cylindrical. The steps may be arranged coaxially with respect to the axis of rotation of the rotor bearing. The steps may have a smaller diameter in an axial direction towards the output opening. A first step may have a smaller diameter than a second step, wherein the first step may be arranged closer to the output opening in an axial direction than the second step. One of the steps may be formed at an axial surface.

In one embodiment, the supply section may be bulged in an axial direction from the guide section toward an outer side such that the supply section is aligned with the main oil channel. Alignment may mean that the supply section is positioned as an extension of the main oil channel. An inner diameter at one end of the main oil channel may be within an inner diameter of the supply section in an axial direction. The supply section may be cylindrical. The diameter of the guide section may be larger than an opening at the end of the main oil channel. The supply section may be bulged from an axial surface of the guide section.

In one embodiment, the guide section may be configured such that it forms an oil volume which is delimited upward by the input opening and which defines the output opening at the bottom. The input opening may be delimited upward with respect to the direction of gravity. The guide section may define the output opening at the bottom with respect to the direction of gravity. The oil volume may provide an oil reserve. In this way, a deficient lubrication in certain operating situations may be avoided.

In an aspect, an oil guiding arrangement for a drive unit is provided. The drive unit includes an electric drive with a rotor, a rotor bearing, and a first gearset. The oil guiding arrangement includes a wall section and a collecting component according to any of the preceding embodiments. The wall section forms the main oil channel. The wall section may form the main oil channel section-wise. The wall section includes a bearing seat for the rotor bearing, which is configured such that the rotor bearing is within the rotor in the axial direction. The output opening is arranged adjacent to the bearing seat in the axial direction. Adjacent may mean that the output opening and the rotor bearing are spaced apart from each other in an axial direction such that oil may flow out of the output opening into a gap between an outer ring and an inner ring of the rotor bearing. The output opening and the rotor bearing may be spaced apart from each other in an axial direction. The rotor bearing and the main oil channel may be spaced apart from each other in an axial direction. The wall section may extend in a radial direction. The output opening may be defined by a cylindrical bore. The output opening may extend in an axial direction and in a radial direction. The output opening may extend in the direction of the rotor bearing.

In an embodiment, the wall section may be configured to collect slung oil which is slung from the first gearset in a circumferential direction during operation. The wall section may include a radial surface in the region around the main oil bore. The radial surface may be aligned in an axial direction. The radial surface may extend substantially in a radial direction so that oil moved in a circumferential direction may impinge on the radial surface.

In one aspect, a drive unit for a vehicle is provided. The drive unit includes an electric drive with a rotor, a rotor bearing, a first gearset, a second gearset, a first output shaft, a second output shaft and an oil guiding arrangement according to any of the preceding aspects or embodiments. The rotor is configured for transmitting a torque to the first gearset. The rotor bearing rotatably supports the rotor at the wall section. The first gearset and the second gearset are mechanically operatively connected to each other such that a torque is transmittable from the first gearset to the second gearset. The first output shaft is configured for outputting a torque from the first gearset. The second output shaft is configured for outputting a torque from the second gearset. The first gearset and the second gearset can be used as differential gears.

In an embodiment, the first gearset may be a first planet gearset. The second gearset may be a second planet gearset. The first gearset may be offset from the second gearset in an axial direction. The first gearset and the second gearset may be in the same plane in an axial direction.

In an aspect, a vehicle includes drive wheels and a drive unit according to any of the preceding aspects or embodiments. The first output shaft is configured for driving one of the drive wheels. The second output shaft is configured for driving another one of the drive wheels.

### BRIEF DESCRIPTION OF THE DRAWINGS

FIG. 1 shows a perspective view of an embodiment of a collecting component.

FIG. 2 shows a front view of an embodiment of the collecting component.

FIG. 3 shows a sectional view of an embodiment of a drive unit with an oil guiding arrangement with the collecting component.

FIG. 4 shows a detail of the sectional view of the embodiment of the drive unit from FIG. 3.

FIG. 5 shows a sectional view of an embodiment of the oil guiding arrangement.

FIG. 6 shows an embodiment of the oil guiding arrangement.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

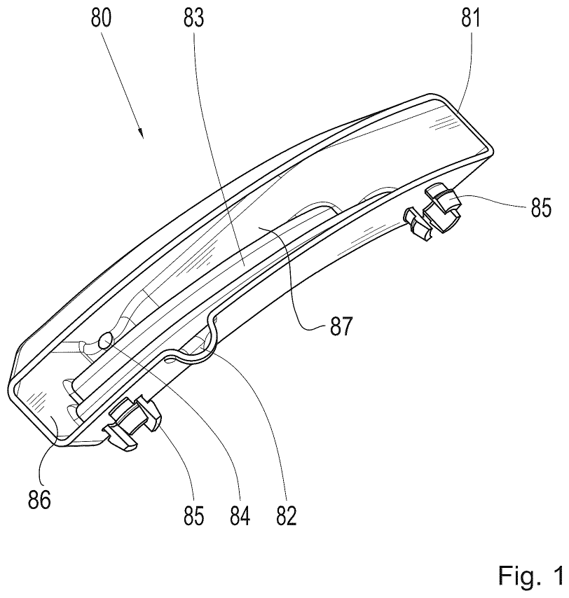

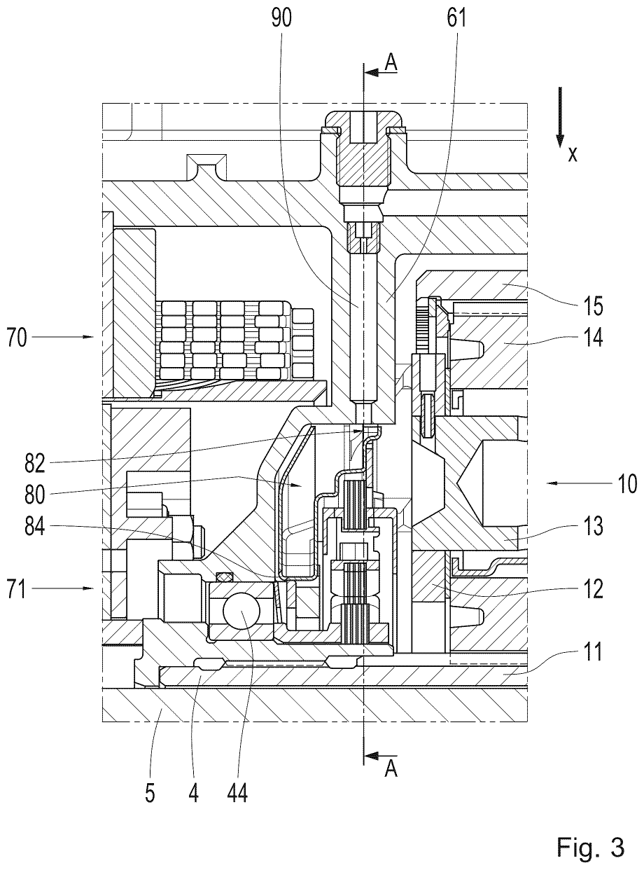

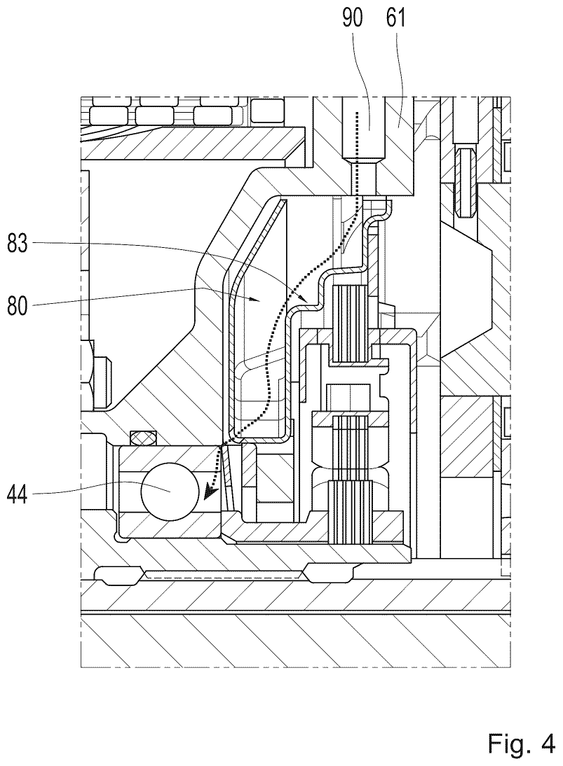

FIG. 1 shows a perspective view of an embodiment of a collecting component 80. The collecting component 80 is applicable for an oil guiding arrangement, which includes a wall section 61, which is shown in FIGS. 3-6. The oil guiding arrangement is applicable for a drive unit which includes a rotor bearing 44, which is depicted in FIGS. 3 and 4. As shown in at least FIG. 1, the collecting component 80 defines an input opening 81, a supply section 82, a guide section 83, an output opening 84, and a fastening section 85.

The wall section 61 forms a main oil channel 90, which will be described in detail with reference to FIG. 3. The collecting component 80 is configured to guide oil from the wall section 61 and a main oil channel 90 to the rotor bearing 44 in an axial direction.

Further details of the collecting component 80 are described below.

The input opening 81 is defined at an upper side of the collecting component 80. The input opening 81 is configured to cover an end face of the wall section 61 in an axial direction. The input opening 81 is configured for both receiving oil dripping from the wall section 61 as well as for receiving oil flowing out of the main oil channel 90. The input opening 81 is rectangular in a circumferential direction.

The supply section 82 partially forms the input opening 81. The supply section 82 is bulged in an axial direction from the guide section 83 toward an outer side. The supply section 82 is formed cylindrically. The supply section 82 extends in a radial direction such that it is aligned with the main oil channel 90 during use as intended.

The guide section 83 is configured for guiding oil from the wall section 61 and the main oil channel 90 to the output opening 84 in an axial direction. The guide section 83 defines a first radial surface 86 and a second radial surface 87 arranged opposite each other in a circumferential direction. The guide section 83 defines axial surfaces arranged in an axial direction. A front axial surface defines two steps. The steps are cylindrical in a circumferential direction. Towards the output opening 84, the steps have a smaller radius and are arranged closer to the output opening 84 in a radial direction. The step, which is arranged closest to the output opening 84 in an axial direction, is also arranged closest to the output opening 84 in a radial direction. In the present case, two steps are defined.

The output opening 84 is defined at an underside of the collecting component 80 and opposite the supply section 82 in the axial direction. The output opening 84 is between lower ends of the radial surfaces 86, 87. The output opening 84 is defined by a cylindrical bore, which extends obliquely in an axial direction and in a radial direction and is aligned in the direction of the rotor bearing 44. The output opening 84 is smaller than the input opening 81 by a multiple.

The fastening section 85 is configured for fastening the collecting component 80 to the wall section 61. In the present case, two fastening sections 85 are provided or defined. The fastening sections 85 are arranged radially symmetrically. The fastening sections 85 are at opposite end portions of the front axial surface in a circumferential direction. The fastening sections 85 are arranged in a radial direction on the outside. Each of the fastening sections 85 has three hooks arranged in a circular manner. The hooks extend in an axial direction. The hooks are spaced a distance from each other such that the hooks may elastically deform towards each other. As a result, the hooks may be hooked into a bore at the wall section 61.

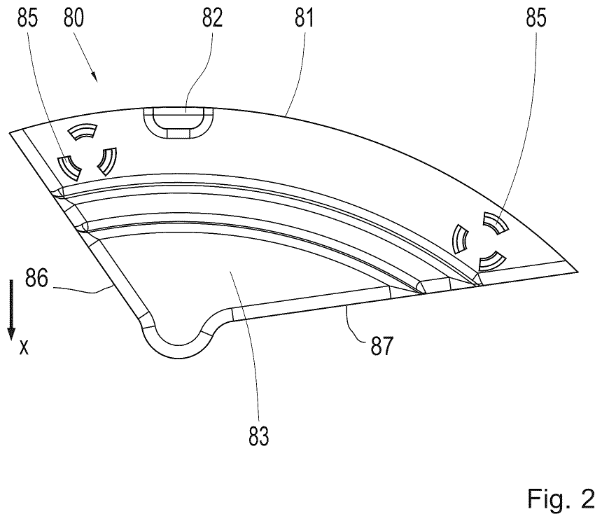

FIG. 2 shows a front view of an embodiment of the collecting component 80. The present embodiment includes all the features of the preceding embodiment. The first radial surface 86 is at the left in FIG. 2 and the second radial surface 87 of the guide section 83 is at the right in FIG. 2, the first and second radial surfaces 86, 87 taper toward each other at an angle in a radial direction. The first radial surface 86 is configured such that it may receive slung oil. The oil is slung counterclockwise in a circumferential direction in FIG. 2. The first radial surface 86 is configured steeper than the second radial surface 87 with respect to the direction of gravity X. The first radial surface 86 and the second radial surface 87 are arranged in a funnel-shaped manner and extend radially outwardly to the input opening 81.

An oil volume is defined within the guide section 83. The upper side of the oil volume is represented by horizontal lines. The upper horizontal line represents the maximum oil volume in the guide section 83 and forms an oil reservoir with which the rotor bearing 44 may be lubricated, even if no oil flows into the input opening 81. In this case, the oil volume is reduced in the guide section 83. The reduced oil volume is represented by the lower horizontal line.

In the preceding embodiment, the supply section 82 and the main oil channel 90 are aligned obliquely to the direction of gravity X. In an alternative embodiment, the supply section 82 and the main oil channel 90 are aligned in the direction of gravity X.

FIG. 3 shows a sectional view of an embodiment of a drive unit with an oil guiding arrangement with the collecting component 80. The drive unit includes an electric drive with a stator 70 and a rotor 71, a rotor bearing 44, a first gearset, in the present case a first planet gearset 10, a second gearset (not shown), in the present case a second planet gearset, a first output shaft 5, and the oil guiding arrangement with the wall section 61 and the collecting component 80 according to any of the preceding embodiments.

The first gearset includes a first sun gear 11, a first planet carrier 12, a number of first planet bolts 13, a number of first planet gears 14, and a first ring gear 15. The first sun gear 11 is in engagement with one of the first planet gears 14. One of the first planet gears 14 is in engagement with the first ring gear 15 and rotatably supported on one of the first planet bolts 13. The first planet bolts 13 are connected to the first planet carrier 12. The second gearset is arranged offset from the first gearset in an axial direction and is not shown in FIG. 3.

An input element 4 is rotationally fixedly connected to the rotor 71. The input element 4 forms the first sun gear 11 on an outer circumference. Thus, the rotor 71 is configured for transmitting a torque to the first gearset. Within the input element 4, the first output shaft 5 extends coaxially with respect to the input element 4.

The rotor bearing 44 rotatably supports the rotor 71 at the wall section 61. The rotor bearing 44 is within the stator 70 in a radial direction and in an axial direction.

The main oil channel 90 extends vertically in the direction of gravity X. The main oil channel 90 is arranged offset from the rotor bearing 44 in an axial direction. The main oil channel 90 has or defines a taper at its end in the oil flow direction, in the present case, the main oil channel 90 has an oil nozzle with an inner diameter. The main oil channel 90 is formed by a cylindrical bore. The main oil channel 90 includes an oil throttle at its start in the oil flow direction that may be screwed in. An inner diameter of the oil throttle, which serves as an oil passage, is smaller than the inner diameter of the oil nozzle.

The wall section 61 includes a sheet metal component extending in a circumferential direction. The collecting component 80 is fastened to the sheet metal component by the two fastening sections 85. The collecting component 80 is fastened to the wall section 61 such that the supply section 82 is aligned with the main oil channel 90. The collecting component 80 is fastened to the wall section 61 such that the output opening 84 is aligned toward the rotor bearing 44. The distance between the output opening 84 and the rotor bearing 44 in the axial direction is so small that oil may flow out of the output opening 84 between an outer ring and an inner ring of the rotor bearing 44. The collecting component 80 is thus configured to guide oil from the main oil channel 90 to the rotor bearing 44.

FIG. 4 shows a detail of the sectional view of the embodiment of the drive unit from FIG. 3. The oil flow direction of the oil guiding arrangement is shown in FIG. 4 by a dashed arrow. The oil flows from the main oil channel 90 out of the wall section 61 via the guide section 83 of the collecting component 80 to the rotor bearing 44.

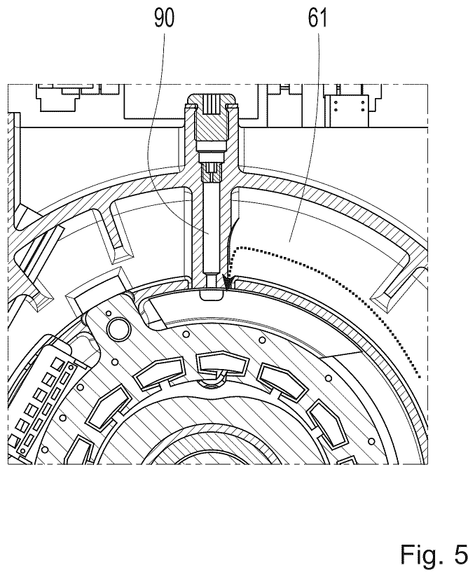

FIG. 5 shows a sectional view of an embodiment of the oil guiding arrangement. The present embodiment includes all the features of any of the preceding embodiments. The sectional view of FIG. 5 is produced via the dashed line A-A in FIG. 3.

The wall section 61 is configured to collect slung oil which is slung from the first gearset in a circumferential direction during operation. For this purpose, the wall section 61 defines a radial surface. The radial surface extends in a radial direction and is aligned in an axial direction. Thus, the radial surface of the wall section 61 is aligned transversely to the circumferential direction. The radial surface is formed in the wall section 61 at a wall region surrounding the main oil channel 90. As a result, the radial surface extends in an axial direction away from an end face of the wall section 61 that is visible in FIG. 5. The oil flow, which is intercepted by the wall section 61, is represented by a dashed arrow.

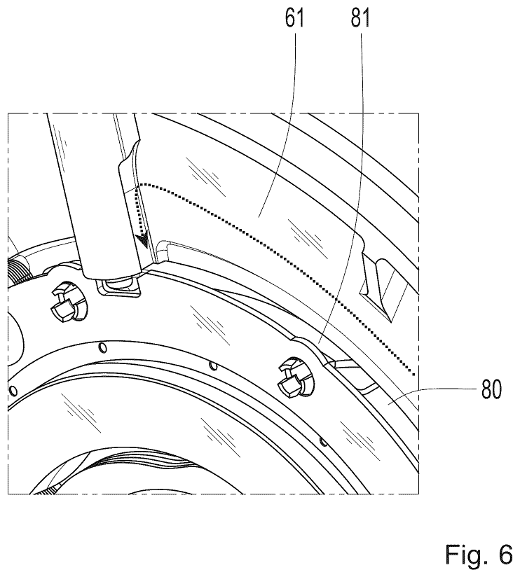

FIG. 6 shows an embodiment of the oil guiding arrangement. The present embodiment includes all the features of the embodiment described with reference to FIG. 5.

The input opening 81 protrudes beyond the end face of the wall section 61 in an axial direction. Thus, the collecting component 80 is configured such that it can collect oil dripping from the wall section 61. Furthermore, as in FIG. 5, the flow of the slung oil, which is intercepted by the radial surface of the wall section 61, is represented by a dashed arrow.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE SIGNS

4 input element
5 first output shaft
10 first planet gearset
11 first sun gear of the first planet gearset
12 first planet carrier of the first planet gearset
13 first planet bolt of the first planet gearset
14 first planet gear of the first planet gearset
15 first ring gear of the first planet gearset
44 rotor bearing
61 wall section
70 stator
71 rotor
80 collecting component
81 input opening
82 supply section
83 guide section
84 output opening
85 fastening section
86 first radial surface
87 second radial surface
90 main oil channel
X direction of gravity

1-11. (canceled)

12. A collecting component (80) for an oil guiding arrangement, the oil guiding arrangement comprising a wall section (61) defining a main oil channel (90), the collecting component (80) comprising:
a body defining:
an input opening (81), the input opening (81) being defined at an upper side of the collecting component (80), the input opening (81) being configured for both receiving oil dripping from the wall section (61) and oil flowing out of the main oil channel (90);
a supply section (82), the input opening (81) being at least partially defined by the supply section (82);
an output opening (84), the output opening (84) being defined at an underside of the collecting component (80), the output opening (84) being defined in the collecting component (80) opposite the supply section (82) in an axial direction;
a guide section (83), the guide section (83) being configured for guiding oil from the wall section (61) and the main oil channel (90) to the output opening (84) in the axial direction; and
a fastening section (85), the fastening section (85) being configured for fastening the collecting component (80) to the wall section (61).

13. The collecting component (80) of claim 12, wherein the guide section (83) defines a first radial surface (86) and a second radial surface (87), the first radial surface (86) and the second radial surface (87) being opposite each other in a circumferential direction and tapering toward each other at an angle in a radial direction,
wherein the first radial surface (86) is configured to receive slung oil, and
wherein the first radial surface (86) is steeper than the second radial surface (87).

14. The collecting component (80) according to claim 12, wherein axial surfaces of the body are arranged laterally in the axial direction are substantially parallel to each other.

15. The collecting component (80) of claim 12, wherein the guide section (83) defines at least one step.

16. The collecting component (80) of claim 12, wherein the supply section (82) bulges outwardly in the axial direction from the guide section (83) such that the supply section (82) is aligned with the main oil channel (90).

17. The collecting component (80) of claim 12, wherein the guide section (83) defines an oil volume, an upper end of the oil volume being delimited by the input opening (81) and a bottom end of the oil volume being delimited by the output opening (84).

18. An oil guiding arrangement for a drive unit comprising an electric drive with a rotor (71), a rotor bearing (44), and a first gearset, the oil guiding arrangement comprising:
the collecting component (80) of claim 12; and
the wall section (61), the wall section (61) defining the main oil channel (90), the wall section (61) including a bearing seat for the rotor bearing (44) within the rotor (71) in the axial direction, the output opening (84) being adjacent to the bearing seat in the axial direction.

19. The oil guiding arrangement of claim 18, wherein the wall section (61) is configured to collect oil slung from the first gearset in a circumferential direction during operation.

20. A drive unit for a vehicle with an electric drive, comprising:
the oil guiding arrangement of claim 18;
the rotor (71);
the rotor bearing (44), the rotor bearing (44) rotatably supporting the rotor (71) at the wall section (61);
the first gearset, the rotor (71) being configured for transmitting torque to the first gearset;
a second gearset, the first gearset and the second gearset being mechanically operatively connected to each other such that torque is transmittable from the first gearset to the second gearset;
a first output shaft (5), the first output shaft (5) being configured for outputting torque from the first gearset; and
a second output shaft (6), the second output shaft (6) being configured for outputting a torque from the second gearset.

21. The drive unit of claim 20, wherein the first gearset is a first planet gearset (10), and the second gearset is a second planet gearset (20).

22. A vehicle, comprising:
drive wheels (8); and
the drive unit of claim 20, the first output shaft (5) of the drive unit being configured for driving one of the drive wheels (8), the second output shaft (6) of the drive unit being configured for driving another one of the drive wheels (8).
